(19) United States
(12) Patent Application Publication
(10) Pub. No.: US 2008/0150302 A1
(43) Pub. Date: Jun. 26, 2008

(54) Bolt Assembly for Lock

(76) Inventor: Chung-Liang Lin, Annan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/046,512

(22) Filed: Mar. 12, 2008

Related U.S. Application Data
(63) Continuation-in-part of application No. 11/307,996, filed on Mar. 2, 2006.

(51) Int. Cl. E05C 1/02

(52) U.S. Cl. 292/137

(57) ABSTRACT

A bolt assembly includes a bolt head, a draw bar, and a pin. The bolt head includes a latching portion and an attachment portion. The attachment portion includes an axial bore and a pin hole extending in a direction transverse to the axial bore and intersecting the axial bore. The draw bar includes a front end mounted in the axial bore of the attachment portion. The front end of the draw bar includes a notch that is aligned with the pin hole. The rear end of the draw bar includes a reference face in a fixed positional relationship to a bottom wall of the notch. The pin is mounted in the pin hole of the attachment portion and the notch of the draw bar, securing the bolt head and the draw bar together. The reference face indicates the orientation of the notch when the notch is received in the axial bore of the attachment portion.

### CROSS REFERENCE TO RELATED APPLICATION

This is a continuation-in-part application of U.S. patent application Ser. No. 11/307,996 filed Mar. 2, 2006.

### BACKGROUND OF THE INVENTION

The present invention relates to a bolt assembly for a door lock and, more particularly, to a bolt assembly including a draw bar with improved structural strength while allowing easy assembly.

A door lock typically includes a latch bolt and a dead bolt, wherein the latch bolt can be retracted by turning either handle. U.S. Pat. No. 5,697,653 discloses a bolt assembly including a bolt body, a draw bar, and a spring pin. The bolt body has a tapered latching end and an attachment end. The attachment end has a cylindrical axial bore and a transverse drilled hole, of a small diameter compared to the axial bore, intersecting the axial bore such that the outer edge of the drilled hole is substantially tangent to the axial bore. The draw bar has a diameter which makes a snug fit in the axial bore when inserted therein and which is circumscribed by a groove. The groove is of a depth and width equal to the diameter of the drilled hole. The spring pin is pressed into the drilled hole and the groove to secure the draw bar to the bolt body. Although it is not necessary to particularly align the axial bore with the annular groove of the draw bar during assembly of the spring pin, the annular groove adversely affects the strength of the draw bar. Namely, the draw bar is liable to break.

A need exists for a draw bar with improved structural strength while allowing easy assembly.

### BRIEF SUMMARY OF THE INVENTION

The present invention solves this need and other problems in the field of door locks by providing, in a preferred form, a bolt assembly including a bolt head, a draw bar, and a pin. The bolt head includes a latching portion and an attachment portion. The attachment portion includes an axial bore and a pin hole extending in a direction transverse to the axial bore and intersecting the axial bore. The draw bar includes a front end mounted in the axial bore of the attachment portion. The front end of the draw bar includes a notch that is aligned with the pin hole. The rear end of the draw bar includes a reference face in a fixed positional relationship to a bottom wall of the notch. The pin is mounted in the pin hole of the attachment portion and the notch of the draw bar, securing the bolt head and the draw bar together The reference face indicates the orientation of the notch even when the notch is received in the axial bore of the attachment portion, allowing easy assembly with the pin.

In the most preferred form, the reference face is a chamfered face extending in a direction parallel to the bottom wall of the notch and spaced from the bottom wall of the notch along a longitudinal axis of the draw bar. The rear end of the draw bar further includes another chamfered face opposite to and parallel to the chamfered face. The chamfered faces allow the draw bar to be securely clamped in a fixture during assembly with the pin.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a lock with a bolt assembly according to the preferred teachings of the present invention and a portion of a door to which the lock is mounted.

FIG. 2 shows an exploded, perspective view of the bolt assembly according to the preferred teachings of the present invention.

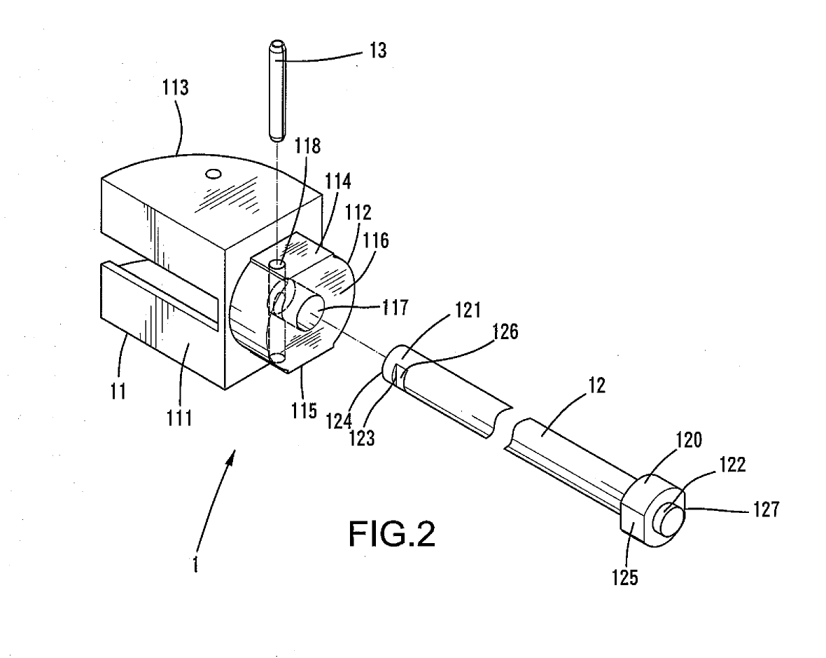

FIG. 3 shows a cross sectional view of the bolt assembly of FIG. 2.

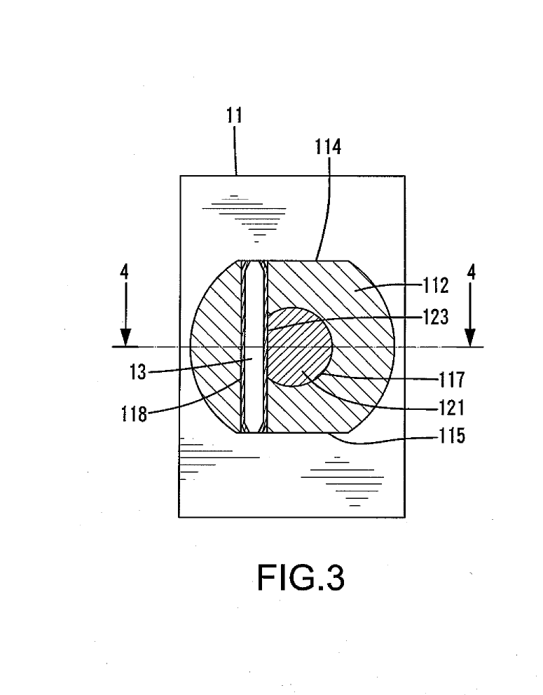

FIG. 4 shows a sectional view of the bolt assembly of FIG. 2 taken along section line 4-4 of FIG. 3.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “top”, “bottom”, “front”, “rear”, “inner”, “outer”, “end”, “portion”, “longitudinal”, “axial”, “inward”, “length”, “width”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

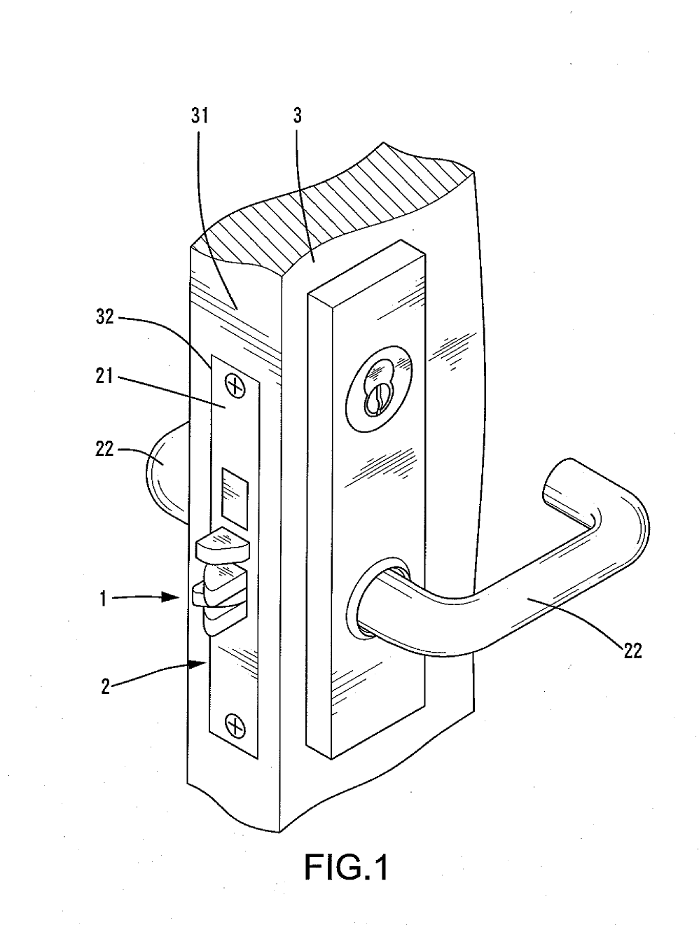

FIG. 1 illustrates a lock 2 mounted to a door 3 and utilizing a bolt assembly 1 according to the preferred teachings of the present invention. The lock 2 includes a lock case 21 mounted in a compartment 32 in an edge 31 of the door 3 and inner and outer handles 22. The bolt assembly 1 is mounted in the lock case 21 and moveable between an extended position (see FIG. 1) and a retracted position under operation of either of the inner and outer handles 22.

According to the preferred form shown, the bolt assembly 1 includes a bolt head 11, a draw bar 12, and a pin 13. The bolt head 11 includes a latching portion 111 that extends out of the case 21 when in the extended position. The bolt head 11 further includes an attachment portion 112 extending from a rear of the latching portion 111. The latching portion 111 is generally tapered (see tapering 113). The attachment portion 112 includes a top face 114, a bottom face 115, and an outer end face 116. In the most preferred form shown, the faces 114, 115, and 116 are substantially planar. An axial bore 117 extends inward into the attachment portion 112 from the outer end face 116 to a depth. In the most preferred form shown, the depth of the axial bore 117 is greater than a half of an axial length of the attachment portion 112. The attachment portion 112 farther includes a pin hole 118 extending in a direction transverse to the axial bore 117. The pin hole 118 extends from the top face 114 through the bottom face 115. The pin hole 118 intersects the axial bore 117 by a half of the pin hole 118.

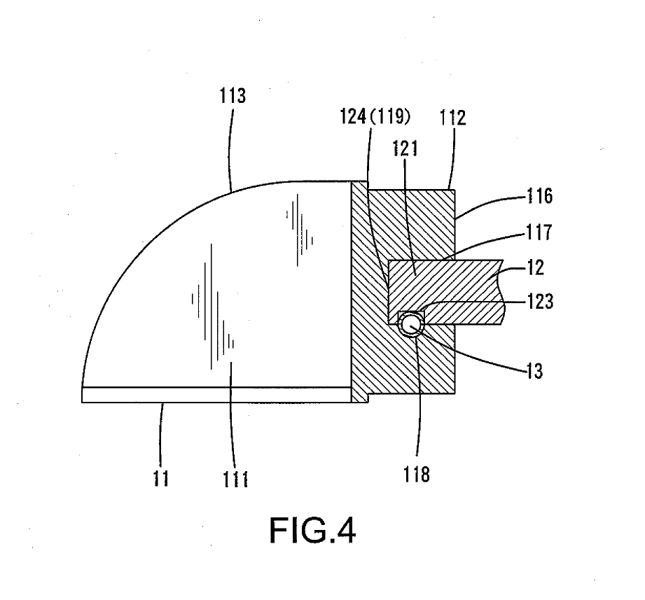

According to the preferred form shown, the draw bar 12 is substantially cylindrical and formed by cold forging. The draw bar 12 includes a front end 121 to be inserted into the axial bore 117 and a rear end 122 to which a spring (not shown) or the like is engaged. A notch 123 is defined in a portion of a circumference of the front end 121. According to the most preferred form shown, a distance from the notch 123 to a front end face 124 of the draw bar 12 is the same as that from the pin hole 118 to an inner end wall 119 delimiting the axial bore 117 such that the notch 123 is aligned (with or without adjustment) with the pin hole 118 when the draw bar 12 comes in contact with the inner end wall 119 delimiting the axial bore 117. The notch 123 has a width along a longitudinal axis of the draw bar 12 (and in an axial direction of the axial bore 117). The width of the notch 123 is the same as a diameter of the pin hole 118. The notch 123 further has a depth from a bottom wall 126 of the notch 123 to the circumference of the draw bar 12 and transverse to the width of the notch 123. The depth of the notch 123 is the same as a radius of the pin hole 118 (FIG. 4). The rear end 122 of the draw bar 12 includes a reference face 125 that is in a fixed positional relationship to the notch 123 for indicating orientation of the notch 123. According to the preferred form shown, the reference face 125 is in the form of a chamfered face extending in a direction parallel to the bottom wall 126 of the notch 123 and spaced from the bottom wall 126 of the notch 123 along the longitudinal axis of the draw bar 12. According to the most preferred form shown, the rear end 122 of the draw bar 12 further includes a chamfered face 127 opposite to and parallel to the reference face 125 to allow easy clamping during assembly with the pin 13. After cold forging, the rear end 122 of the draw bar 12 is processed to provide the chamfered faces 125 and 127. Then, the front end 121 of the draw bar 12 is milled to form the notch 123 during which the draw bar 12 is securely clamped by the chamfered faces 125 and 127. It can be appreciated that the structural strength of the draw bar 12 with such a notch 123 is not largely sacrificed.

The pin 13 has a diameter allowing it to be tightly engaged in the pin hole 118. According to the most preferred form shown, the pin 13 has a length the same as that of the pin hole 118. When the front end 121 of the draw bar 12 is inserted into the axial bore 117 of the attachment portion 112 of the bolt head 11, with the notch 123 of the draw bar 12 aligned with the pin hole 118, the pin 13 can be then inserted into the pin hole 118 and through the notch 123 to secure the draw bar 12 and the bolt head 11 together.

In assembly, the front end 121 of the draw bar 12 is inserted into the axial bore 117 of the bolt head 11 until the front end face 124 of the draw bar 12 comes in contact with the inner end wall 119 delimiting the axial bore 117, with the notch 123 aligned with the pin hole 118. It can be appreciated that assembly of the draw bar 12 and the bolt head 11 can be accomplished by a worker or robot. The draw bar 12 and the bolt head 11 are then placed on a fixture that securely holds the draw bar 12 and the bolt head 11. The draw bar 12 and the bolt head 11 can be placed on the fixture by a worker or robot. The fixture securely holds the rear end 122 of the draw bar 12 by the faces 125 and 127. Then, the pin 13 is punched into the pin hole 118, with a half of the pin 13 engaged in the notch 123. In a case that the notch 123 of the draw bar 12 is slightly misaligned with the pin hole 118, the pin 13 passing through the notch 123 will impinge the bottom wall 126 of the notch 123 and cause the draw bar 12 to turn slightly to a completely aligned position. Thus, the draw bar 12 and the bolt head 11 can be rapidly and easily secured together, for the reference face 125 indicates the orientation of the notch 123 when the notch 123 is received in the axial bore 117 of the attachment portion 112. Furthermore, the chamfered faces 125 and 127 allow the draw bar 12 to be securely held in place in the fixture during assembly with the pin 13, which assures alignment of the notch 123 of the draw bar 12 with the pin hole 118.

Now that the basic teachings of the present invention have been explained, many extensions and variations will be obvious to one having ordinary skill in the art. For example, the reference face 125 can be perpendicular or at a fixed angle to the bottom wall 126 of the notch 123. Furthermore, the faces 125 and 127 can be of other shapes other than planar without adversely affecting the holding effect by the fixture. Further, the face 127 can be omitted when desired.

The faces 125 and 127 at the rear end 122 of the draw bar 12 according to the preferred teachings of the present invention allow the draw bar 12 to be securely clamped during formation of the notch 123 in the front end 121. Furthermore, the faces 125 and 127 at the rear end 122 of the draw bar 12 according to the preferred teachings of the present invention allow the draw bar 12 to be securely held by the fixture during assembly with the pin 13. Further, alignment of the notch 123 of the draw bar 12 with the pin hole 118 of the bolt head 11 according to the preferred teachings of the present invention is assured by the faces 125 and 127 held by the fixture during assembly with the pin 13, for the reference face 125 is in a fixed positional relationship to the bottom wall 126 of the notch 123. The draw bar 12 according to the preferred teachings of the present invention has improved structural strength than conventional ones while allowing easy and rapid assembly of the bolt assembly 1.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A bolt assembly comprising:
a bolt head including a latching portion and an attachment portion, with the attachment portion including an axial bore and a pin hole extending in a direction transverse to the axial bore and intersecting the axial bore;
a draw bar including a front end mounted in the axial bore of the attachment portion, with the front end of the draw bar including a notch that is aligned with the pin hole, with the notch including a bottom wall, with the draw bar further including a rear end outside the axial bore and opposite and spaced from the front end, with the rear end including a reference face in a fixed positional relationship to the bottom wall of the notch; and
a pin mounted in the pin hole of the attachment portion and the notch of the draw bar, securing the bolt head and the draw bar together.

2. The bolt assembly as claimed in claim 1, with the reference face being a chamfered face extending in a direction parallel to the bottom wall of the notch and spaced from the bottom wall of the notch along a longitudinal axis of the draw bar.

3. The bolt assembly as claimed in claim 2, with the rear end of the draw bar further including another chamfered face opposite to and parallel to the chamfered face, with the chamfered face and the other chamfered face being adapted to be securely held by a fixture while the pin is being mounting into the pin hole and the notch.

4. The bolt assembly as claimed in claim 2, with the attachment portion of the bolt head including a top face and a bottom face opposite the top face, and with the pin hole extending from the top face through the bottom face of the attachment portion.

5. The bolt assembly as claimed in claim 4, with the pin hole having two equal parts, with one of the two equal parts being a half of the pin hole, and with the pin hole intersecting the axial bore by the half of the pin hole.

6. The bolt assembly as claimed in claim 5, with the draw bar including a front end face, with the axial bore of the attachment portion including an inner end wall, and with a distance from the notch to the front end face of the draw bar being equal to a length from the pin hole to the inner end wall.

7. The bolt assembly as claimed in claim 6, with the notch having a width extending in an axial direction of the axial bore, with the pin hole having a diameter, with the width of the notch being equal to the diameter of the pin hole, with the notch having a depth transverse to the width, with the pin hole having a radius, and with the depth of the notch being equal to the radius of the pin hole.
